(19) United States
(12) Patent Application Publication
(10) Pub. No.: US 2018/0017673 A1
(43) Pub. Date: Jan. 18, 2018

(54) Precise Vehicle Association in Automated Traffic Surveillance Using Forward-Look and Side-Look Doppler Radars Traffic Surveillance

(71) Applicants: Lang Hong, Beavercreek, OH (US); Steven Hong, Beavercreek, OH (US)

(72) Inventors: Lang Hong, Beavercreek, OH (US); Steven Hong, Beavercreek, OH (US)

(21) Appl. No.: 15/209,555

(22) Filed: Jul. 13, 2016

(51) Int. Cl. G01S 13/58; G01S 13/87; G01S 13/66

(52) U.S. Cl. CPC G01S 13/581; G01S 13/66; G01S 13/87

(57) ABSTRACT

This invention is related to an automated traffic surveillance system to monitor traffic comprising of a plural number of Doppler radars, circuitry for processing radar signals, and data recording and displaying devices. Although the system is mainly designed for roadside traffic surveillance, it can be used in different applications, such as mounted on a host vehicle. The system will provide continuous surveillance of all incoming and leaving traffic.

### TECHNICAL FIELD

This invention relates to Using Forward-Look and Side-Look Doppler Radars for Precise Vehicle Association in Automated Traffic Surveillance.

### BACKGROUND OF THE INVENTION

Traditional Doppler radar traffic surveillance scenario: In a traditional Doppler radar traffic surveillance scenario, a Doppler radar is aiming at the traffic flow, as shown in FIG. 1 (the forward-look Doppler radar in FIG. 1), which measures a vehicle speed at line-of-sight (LOS). In FIG. 1, the speed of an approaching (or a leaving) vehicle is calculated in terms of Doppler frequency f_{D} by

$${v}_{t} = \frac{{f}_{D}}{K cos ( {φ}_{t} )} \qquad ( 1 )$$

where K is a Doppler frequency conversion constant and φₜ is the angle between the vehicle velocity vector vₜ and the LOS. In a traditional traffic surveillance scenario, φₜ is less than 10 degrees, so cos(φₜ)≈1 and

$${v}_{t} \approx \frac{{f}_{D}}{K} . \qquad ( 2 )$$

However, because the radar energy beam angle, φᵣ in FIG. 1, is not small (typically 12 degrees), several vehicles could be illuminated simultaneously by a radar energy beam. FIG. 2 shows two vehicles being illuminated simultaneously by a radar energy beam. An uncertainty arises when multiple speed readings are associated to multiple vehicles in a radar energy beam. Doppler radar operators try to resolve this uncertainty by experience and visual inspection. However, mistakes do happen due to human errors.

### SUMMARY

This invention solves the problem of associating multiple speed readings to multiple vehicles in a radar energy beam by introducing a secondary side-look Doppler radar and exploring the cosine effect of a Doppler radar (FIG. 3). By partially overlapping the radar energy beams of the forward-look Doppler radar and the side-look Doppler radar, the present invention can precisely associate the vehicles distinctly identified in the side-look radar energy beam to the vehicles in the forward-look radar energy beam. Then reversed Doppler tracking is performed on the both the side-look and forward-look radars with tracks initialized by the side-look radar.

An automated traffic surveillance system to monitor traffic may include a forward-look Doppler radar to generate a first radar energy beam along a traffic surveillance direction, a side-look Doppler radar to generate a radar energy beam along a direction of a certain angle from the direction of the forward-look radar energy beam direction, a data processing unit, a data recording unit, and a display unit.

The surveillance system may calculate the Doppler frequencies for the forward-look and side-look Doppler signals.

The surveillance system may use a time stamp in the Doppler radar signal acquisition.

The surveillance system may find a time when a moving vehicle is passing through its side-look radar energy beam.

The surveillance system may initialize the vehicle trajectories using the side-look Doppler radar signals and pass the initialized vehicle trajectories to the forward-look radar.

The surveillance system may perform reversed Doppler tracking on the initialized vehicles using the forward-look and side-look Doppler radar signals.

The surveillance system may calculate the speeds of the vehicles using the forward-look Doppler signals.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the speed measurement of an approaching vehicle with a Doppler radar;

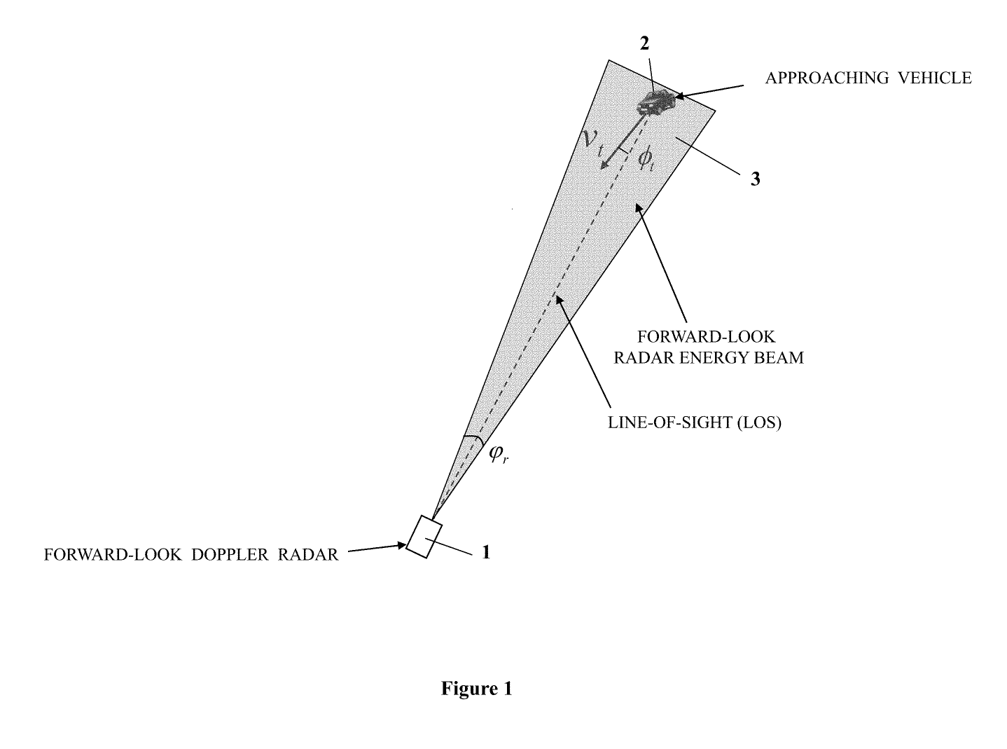

FIG. 2 illustrates the uncertainty in speed measurement of two approaching vehicles with a Doppler radar, where there is no reliable way of associating two speed measurements to two vehicles correctly using only one Doppler radar;

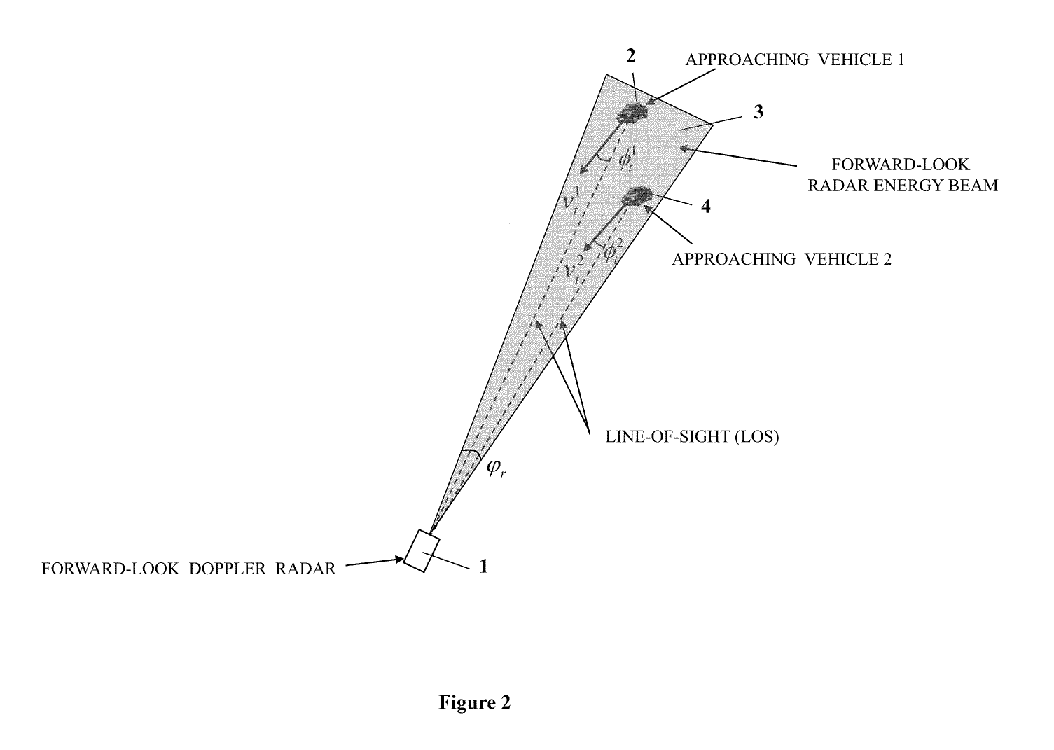

FIG. 3 illustrates the operational setup of the surveillance system which includes a forward-look Doppler radar, a side-look Doppler radar which is orientated away from the forward-look Doppler radar with a certain angle, a data processing unit, a data recording unit, and a display unit;

FIG. 4 illustrates different operation regions of the forward-look Doppler radar and the side-look Doppler radar;

FIG. 5 illustrates different time regions of the forward-look Doppler radar and the side-look Doppler radar, and the cosine effect of a Doppler radar;

FIG. 6 illustrates the time signals of both forward-look and side-look Doppler radars;

FIG. 7 illustrates the frequency (speed) signals of both forward-look and side-look Doppler radars with the vehicles trajectories being initialized by the side-look Doppler radar;

FIG. 8 illustrates the reversed Doppler tracking results.

### DETAILED DESCRIPTION

While the term “traffic surveillance” is used herein, it may also refer to other traffic applications, such as “traffic monitoring”, etc. The invention discussed here may be applied to the case of more than two radars.

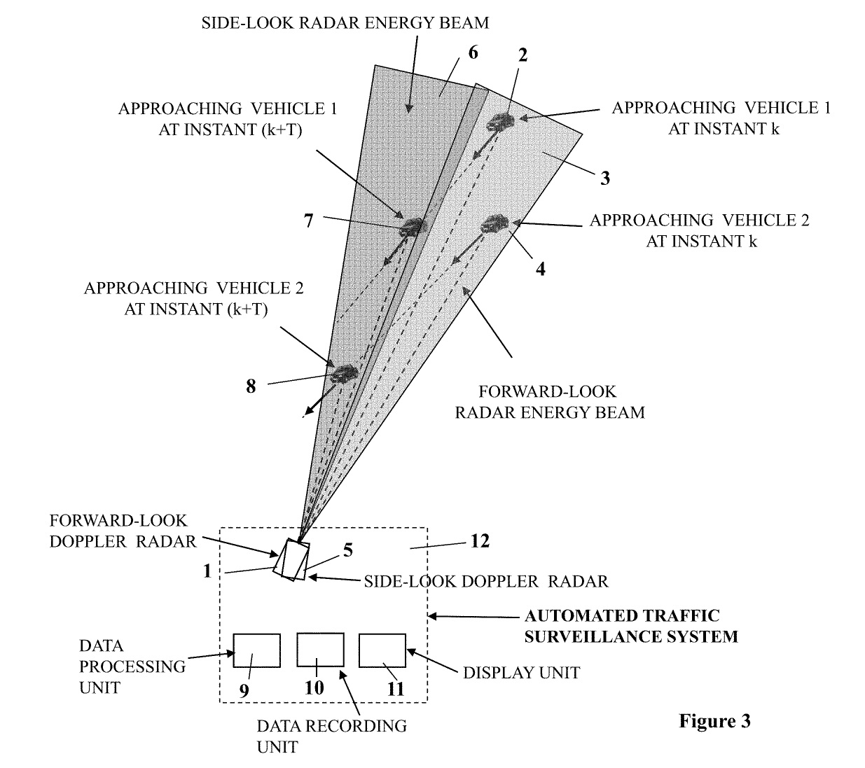

An automated traffic surveillance system apparatus (12) is shown in FIG. 3, where 1—a forward-look Doppler radar, 5—a side-look Doppler radar which is orientated with a certain angle away from the forward-look Doppler radar, 9—a data processing unit, 10—a data recording unit, and 11—a display unit. Two approaching vehicles (2 and 4) move from inside of the forward-look Doppler radar energy beam (3) at time instant k into the side-look Doppler radar energy beam (6) at time instant (k+T).

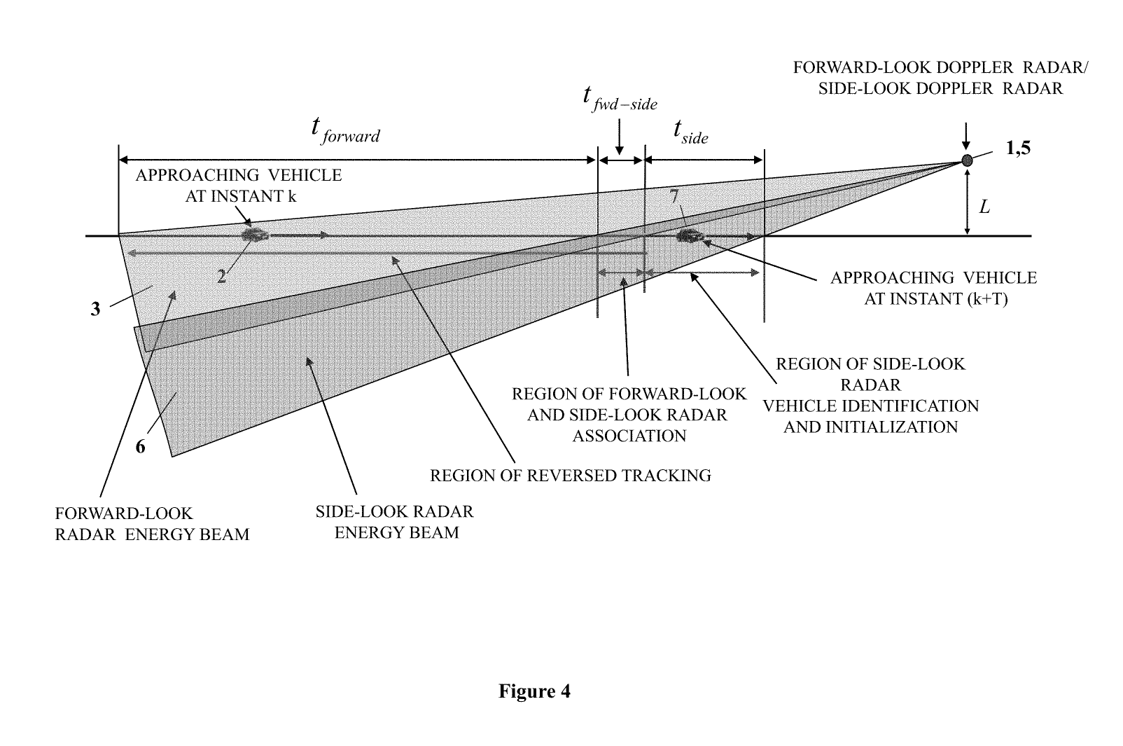

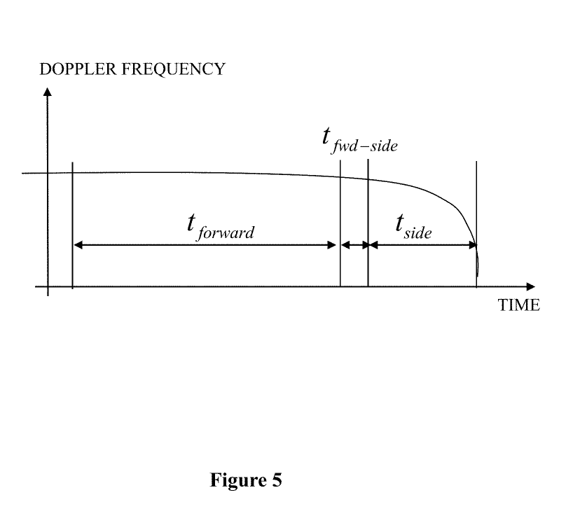

FIGS. 4 and 5 present different operation and time regions in the forward-look and side-look Doppler radars. As an approaching vehicle moves from the forward-look Doppler radar energy beam (3) into the side-look Doppler radar energy beam (6), the famous Doppler radar cosine effect within the Region of Side-Look Radar Vehicle Identification and Initialization in FIG. 4 becomes obvious (the cosine curving segment in the t_{side} region of FIG. 5). Because of this cosine effect, the timing of a vehicle passing through the t_{side} region becomes very distinct and is used to identify and initialize the vehicle trajectory in the side-look Doppler radar 5. The Region of Forward-Look and Side-Look Radar Association in FIG. 4 (or the t_{fwd-side} region in FIGS. 4 and 5) serves a linkage (registration) between the forward-look and the side-look Doppler radars. The vehicle trajectory information initialized in the side-look Doppler radar 5 in the t_{side} region is passed to the forward-look Doppler radar via the linkage in reversed Doppler tracking in the Region of Reversed Tracking in FIG. 4 (or the t_{forward} region in FIGS. 4 and 5).

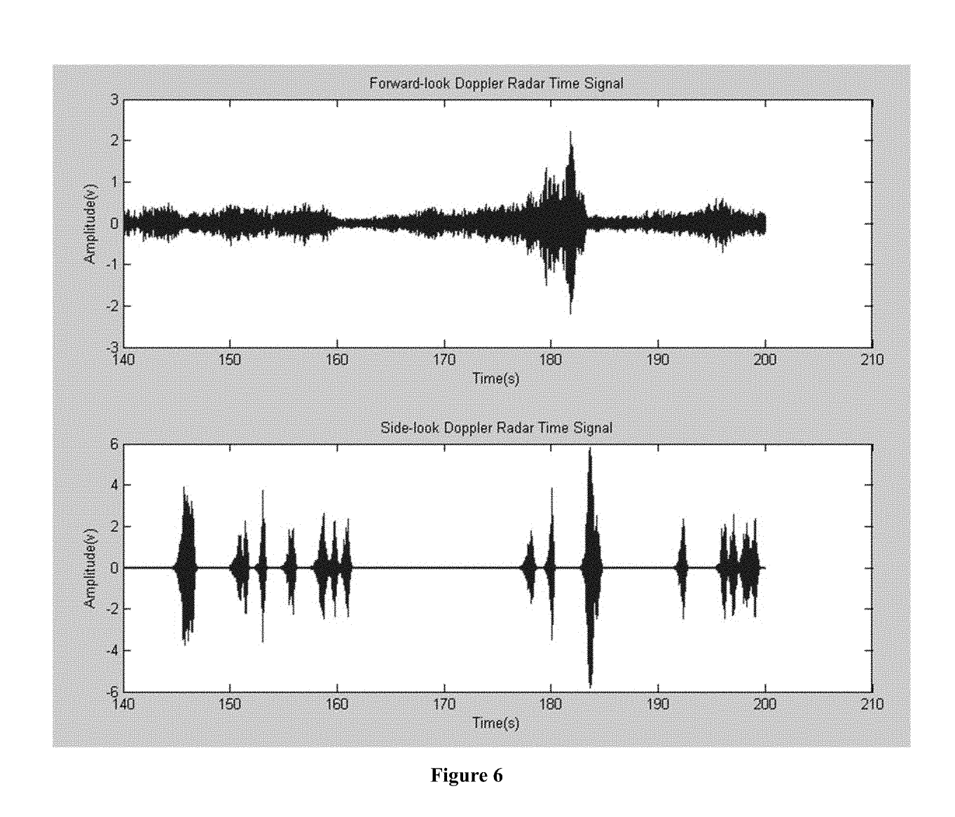

The concept of side-look Doppler radar timing detection is clearly illustrated in FIG. 6. The time signal for the forward-look Doppler radar 1 is shown in the top where no timing information of multiple vehicles can be extracted, and the time signal of the side-look Doppler radar 5 is shown in the bottom where the timing of each vehicle passing the t_{side} region can be clearly identified.

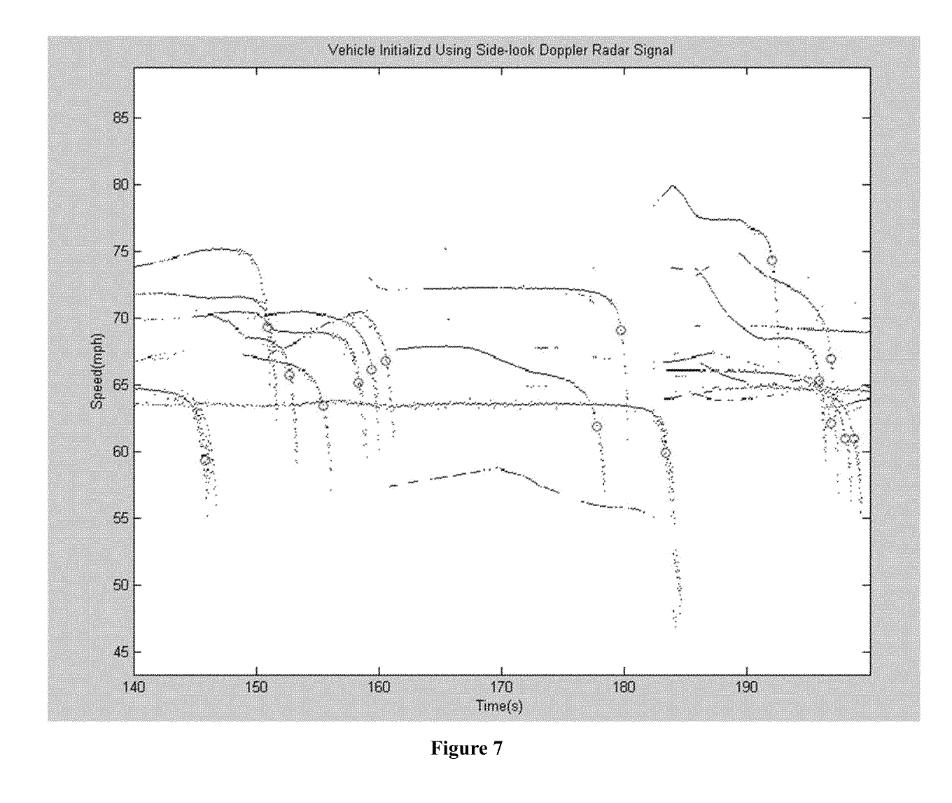

The speed information of the moving vehicles 2, 4 can be derived from the spectrogram. FIG. 7 shows the combined spectrogram of both forward-look and side-look Doppler radars 1, 5 where each vehicle passing the t_{side} side region is uniquely identified and its trajectory is initialized in the side-look Doppler radar 5 and marked as circles in FIG. 7.

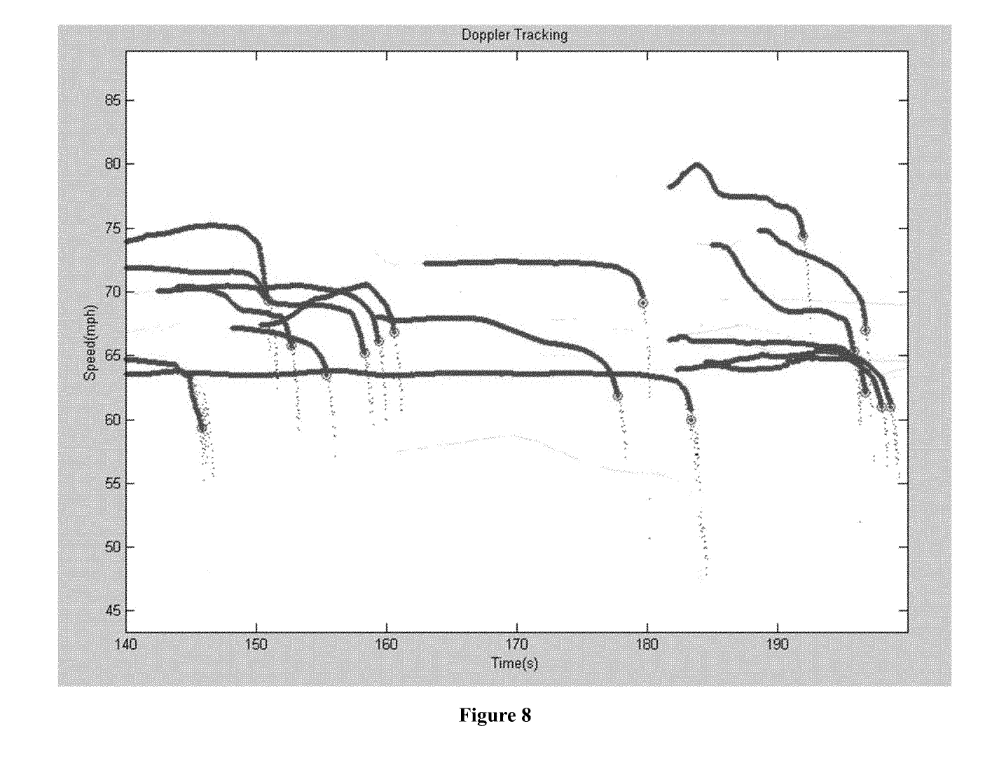

Using reversed Doppler tracking, the vehicle trajectories identified and initialized in the side-look Doppler radar 5 are precisely associated to the vehicle trajectories in the forward-look Doppler 1 and the speed information of each vehicle 2, 4 is uniquely derived. FIG. 8 shows the results of reversed Doppler tracking.

We claim:

1) An automated traffic surveillance system, comprising:
a forward-look Doppler radar to generate a first radar energy beam along a traffic surveillance direction,
a side-look Doppler radar to generate a second radar energy beam along a direction of an angle away from said traffic surveillance direction of said forward-look Doppler radar,
a data processing unit,
a data recording unit, and a display unit,
wherein said system calculates the Doppler frequencies of a first moving vehicle and a second moving vehicle from said forward-look and side-look Doppler radar signals to determine a first speed of the first vehicle and the second speed of the second vehicle.

2) An automated traffic surveillance system, comprising:
a forward-look Doppler radar to generate a first radar energy beam along a traffic surveillance direction,
a side-look Doppler radar to generate a second radar energy beam along a direction of an angle away from said traffic surveillance direction of said forward-look Doppler radar,
a data processing unit,
a data recording unit, and a display unit,
wherein said system uses a time stamp in said side-look Doppler radar signal to identify a first moving vehicle and a second moving vehicle passing through said radar energy beam of said side-look Doppler radar to determine a first speed of the first vehicle and the second speed of the second vehicle.

3) An automated traffic surveillance system as in claim 2, wherein said system initializes first and second vehicle trajectories using said side-look Doppler radar signals and said time stamp and transmits the said initialized vehicle trajectories to said forward-look Doppler radar.

4) An automated traffic surveillance system as in claim 3, wherein said system performs reversed Doppler tracking on said initialized vehicle trajectories using said forward-look Doppler radar and side-look Doppler radar signals.

5) An automated traffic surveillance system, comprising:
a forward-look Doppler radar to generate a first radar energy beam along a first traffic surveillance direction,
a side-look Doppler radar to generate a second radar energy beam along a second traffic surveillance direction at an angle with respect to said first traffic surveillance direction of said forward-look Doppler radar,
a data processing unit,
a data recording unit, and a display unit,
wherein said data processing unit calculates the first speed of a first moving vehicle and a second speed of a second moving vehicle whose trajectories have been tracked by a reversed Doppler tracking.
